(19) United States
(12) Patent Application Publication
(10) Pub. No.: US 2008/0104848 A1
(43) Pub. Date: May 8, 2008

(54) Reciprocating pipe cutter

(76) Inventors: Brian S. Cooke, Novato, CA (US); Kenneth A. Tarlow, Corte Madera, CA (US)

Correspondence Address: BRIAN S. COOKE, P.O. BOX 1842, NOVATO, CA, 94948, US

(21) Appl. No.: 11/593,537

(22) Filed: Nov. 7, 2006

(51) Int. Cl. B26D 3/16

(52) U.S. Cl. 30/92

(57) ABSTRACT

A reciprocating pipe cutter that uses a thin diameter wire saw as a cutting element. The wire saw blade attaches at one end to a reciprocating blade that can is mounted into a standard electrically powered reciprocating saw tool. The saw wire proceeds from the reciprocating blade, around the perimeter of a fixed pulley and then around the perimeter of a pulley mounted to a swingable arm. The wire terminates at its other end to an extension spring. When the electric tool is turned on, the saw wire reciprocates so that when the wire is pushed into the wall of a pipe, it can cut the pipe in two. The swingable arm allows pipes of varying diameters to be cut. The reciprocating pipe cutting tool allows the user to cut a pipe while it is in place without doing damage to near by surfaces.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pipe cutting tools and more specifically to a reciprocating pipe cutter.

The cutting of utility pipes such as water pipes or gas pipes is usually done with known cutting means tools such as hand or electrically powered hack saws, reciprocating saws, abrasive cutoff disks or band saws.

There are occasions where a plumber or other professional tradesman must cut a pipe while the pile is already in place in a home or office. In many cases, the pipe to be cut is located near another object such as a hot water heater or an adjacent wall.

Existing pipe cutting tools, while effective in most cases, have difficulty when it comes to cutting a pipe that is in close proximity to another object or wall.

For example, a plumber may choose to use an electrically powered reciprocating saw with a metal saw blade installed, to cut through a copper water pipe however, the tip of the saw blade may accidentally puncture a wall located behind the pipe, causing additional time to be spent in repairing the damaged wall.

George Montgomery, in his U.S. Pat. No. 3,951,564 shows a cutting blade assembly attached to a hand drill. Although the device can be used in tight spaces, it requires that a portion of the device be positioned behind the pipe to be cut. This may not be possible for a pipe that is placed very close to a wall as well as other nearby objects. Similarly, Timothy Risser, in his U.S. Pat. No. 5,829,142 as well as Kent Meyers in his patent U.S. Pat. No. 7,013,567 also require the user to place a portion of the device behind the pipe to be cut. Fernando Figueredo et al in their U.S. Pat. No. 4,258,763 discloses a cutting device that includes a reciprocating wire saw and does not require the user to have access to the rear of the object being cut, however, the devices described are for large, non pipe cutting applications such as the cutting of a tree. Additionally, no provision is made for cutting pipes of varying diameters.

### BRIEF SUMMARY OF THE INVENTION

The primary object of the invention is to provide a pipe cutter that allows a person to cut an installed plumbing pipe even if there are other fixed objects in close proximity to the pipe.

Another object of the invention is to provide a pipe cutter that does not damage walls or other surfaces that may be in close proximity to the pipe being cut.

Another object of the invention is to provide a pipe cutter that can be easily attached to an electrically powered reciprocating saw tool.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed reciprocating pipe cutter comprising: a saw to pipe cutter interface plate, a reciprocating blade, a saw wire, a blade to wire connection assembly, a fixed pulley retaining bracket, a rotatable pulley retaining arm, a first second and third set of saw wire engaging pulleys, an extension spring, a spring to wire connection assembly and an electrically powered reciprocating saw tool. Said interface plate is attached to the working end of said reciprocating saw tool. Said fixed pulley retaining arm is fixedly attached in a perpendicular orientation to said interface plate. Said fixed pulley arm includes a pinned connection joint to rotatably join one end of said rotatable pulley retaining arm. Said reciprocating blade is attached at one end to said electrically powered saw tool in a standard way. Said reciprocating blade has an aperture at the opposite end to accept said blade to wire connection assembly. One end of said saw wire is attached to said wire connection assembly. Said first pulley is attached to said fixed pulley retaining bracket so that said wire, when attached to said reciprocating blade, can continue and be engaged along the inboard side surface of said first pulley, said saw wire continuing along the length of said fixed bracket the then engage the outboard surface of said second pulley located at the distal end of said fixed bracket, said saw wire continuing until it engages the outboard surface of said third pulley located at the distal end of said rotating pulley retaining arm. Said saw wire terminating at one end of said extension spring by said spring to wire assembly, and said spring being fixedly retained at its opposite end by a standard retaining member to said interface plate.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the pipe cutting tool of the present invention

FIG. 2 is a perspective view showing the connection means of the saw blade assembly to a reciprocating saw.

FIG. 3 is a plan view of the pipe cutting saw blade assembly with arms in closed position.

FIG. 4 is a plan view of the pipe cutting saw blade assembly with the arms in the spread position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

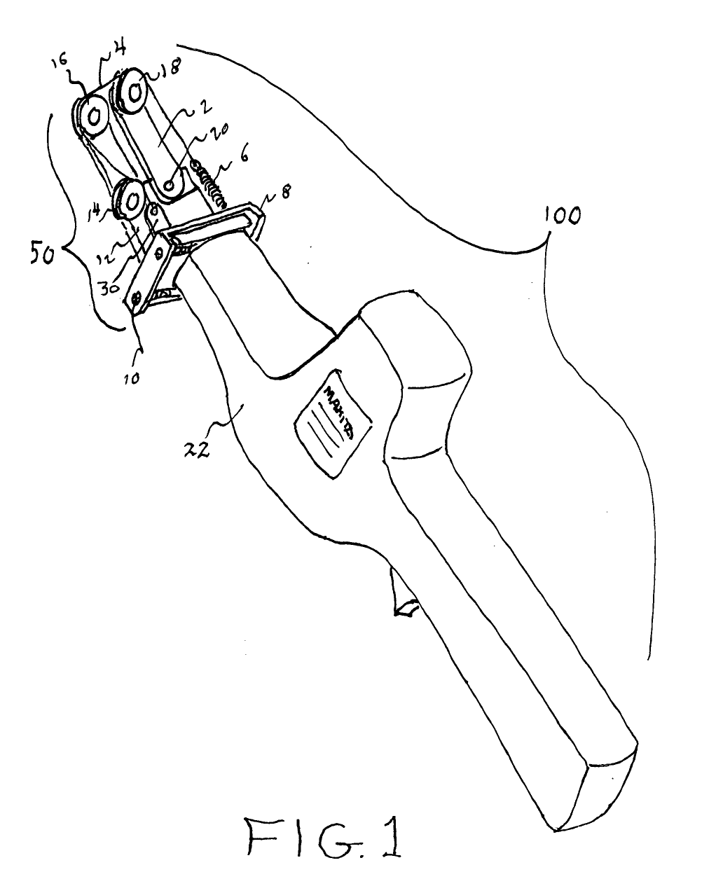

Referring now to FIG. 1 we see a perspective view of the invention 100. A standard reciprocating power saw 22 is attached to a unique wire saw assembly 50. Instead of a traditional saw blade mounted in power saw 22, a blade 30 is inserted a wire saw 4 attaches to the blade 30 and proceeds to be threaded along the inboard edge of pulley 12, then to the outboard edge of pulley 16 and then wrap around the outboard edge of pulley 18 and terminates at extension spring 6. One arm 12 of the saw assembly 50 is fixed, and the other arm 2 is pinned 20 so that it can swing out from fixed arm 12.

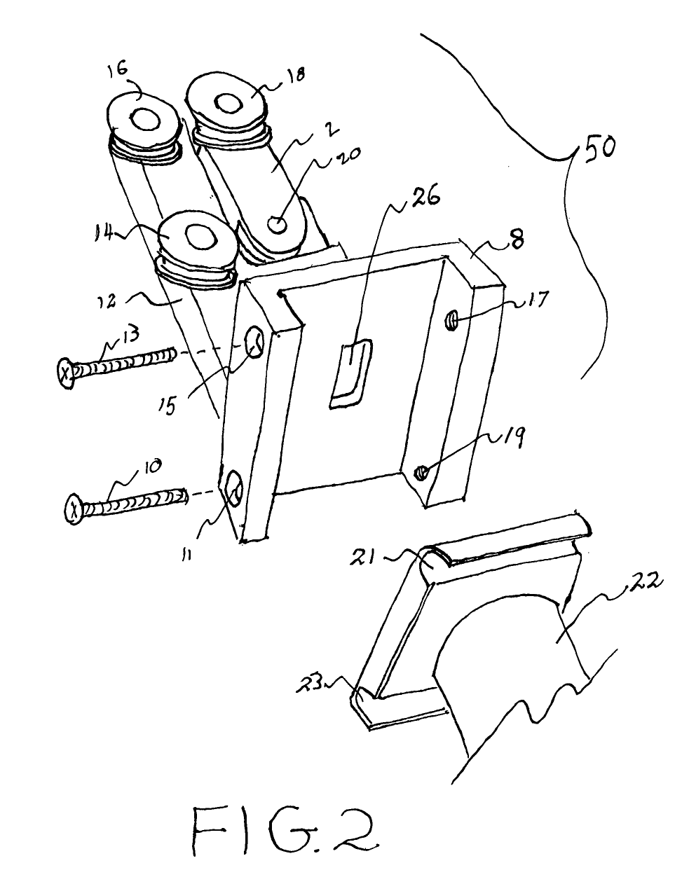

FIG. 2 shows the attachment means of standard reciprocating saw 22 and wire saw assembly 50. In the preferred embodiment, a Makita model number 4390D is used, however it should be noted that other saws may be used or there may be an embodiment of the invention where the reciprocating assembly and the wire saw are manufactured as an integrated unit. In the preferred embodiment, the wire saw assembly 50 can be attached to the Makita saw. In this way, a person can purchase a relatively inexpensive wire saw accessory that can easily attach to a Makita tool. The attachment is made by inserting a pair of screws 10, 13 into apertures 11, 15 and on through channels 21, 23 located on the front plate of the Makita saw. The screws 10, 13 are threaded into apertures 17, 19 to make a secure connection between the power tool 22 and the wire saw accessory 50. This view also shows that pulleys 14, 16, 18, have flanges to help hold the wire saw blade 4 in place. The wire holding blade 30 attaches to the power saw 22 in the standard way and passes through aperture 26.

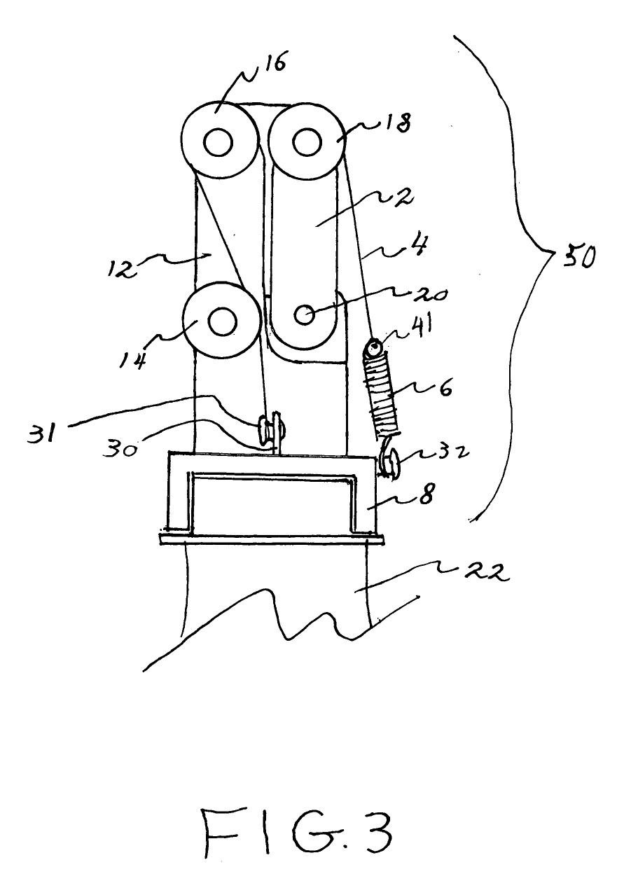

FIG. 3 shows a plan view of the wire saw assembly 50. Wire saw blade 4 is approximately fifteen thousandths of an inch in diameter. The pulleys 14, 16, 18, are approximately one inch in diameter, which matches the minimum bending radius of the wire 4. Arm 2 is shown in the rest position before use. Spring 6 holds the wire 4 taught. The spring 6 is held at its far end by holding post 32. The spring 6 is held to the saw wire 4 by standard retaining assembly 41.

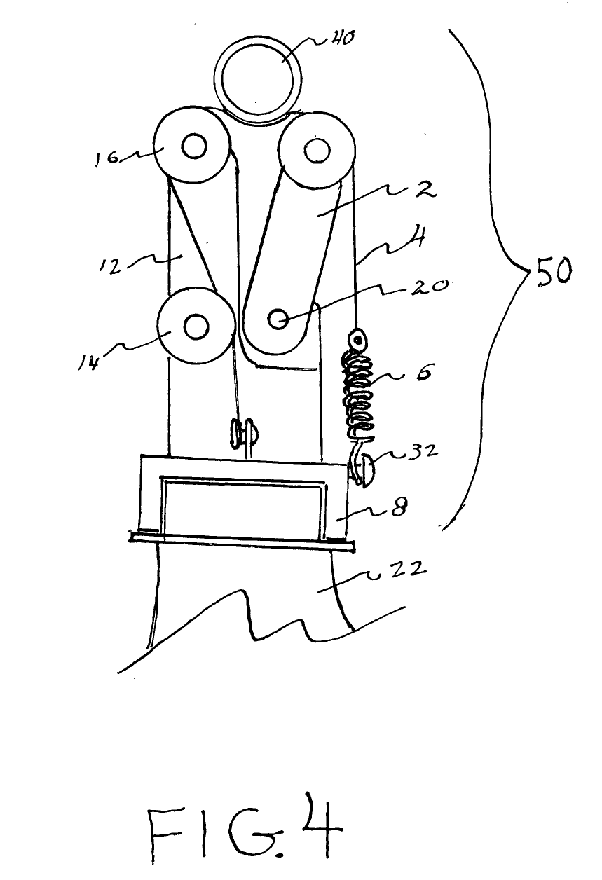

FIG. 4 shows the saw assembly 50 in use and about to cut pipe 40. Arm 2 swings out to make way for the pipe 40 as needed. In this way the cutting wire 4 can accommodate a variety of pipe sizes up to approximately two inches in diameter. The invention 100 does not require the user to access the rear of the pipe to prepare for cutting. Additionally, the total width of the cutting assembly is quite narrow so that the device can be used even if other objects are in close proximity to the pipe being cut. Therefore the present invention 100 is ideal for cutting pipes that are already in place in a residence or commercial establishment and will not cause damage to walls behind the pipe being cut or to objects on either side of the pipe.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. reciprocating pipe cutter comprising:
a saw to pipe cutter interface plate;
a reciprocating blade;
a saw wire;
a blade to wire connection assembly;
a fixed pulley retaining bracket;
a rotatable pulley retaining arm;
a first second and third set of saw wire engaging pulleys;
an extension spring;
a spring to wire connection assembly;
an electrically powered reciprocating saw tool;
said interface plate attached to the working end of said reciprocating saw tool;
said fixed pulley retaining arm fixedly attached in a perpendicular orientation to said interface plate;
said fixed pulley arm including a pinned connection joint to rotatably join one end of said rotatable pulley retaining arm;
said reciprocating blade attached at one end to said electrically powered saw tool in a standard way;
said reciprocating blade having an aperture at the opposite end to accept said blade to wire connection assembly;
one end of said saw wire attached to said wire connection assembly;
said first pulley attached to said fixed pulley retaining bracket so that said said wire, when attached to said reciprocating blade, can continue and be engaged along the inboard side surface of said first pulley;
said saw wire continuing along the length of said fixed bracket the then engage the outboard surface of said second pulley located at the distal end of said fixed bracket;
said saw wire continuing until it engages the outboard surface of said third pulley located at the distal end of said rotating pulley retaining arm;
said saw wire terminating at one end of said extension spring via said spring to wire assembly; and
said spring being fixedly retained at its opposite end by a standard retaining member to said interface plate.

2. reciprocating pipe cutter as claimed in claim 1 wherein said electric reciprocating saw tool is a :Makita model 4390D portable type tool and said pipe cutter interface plate includes side walls having apertures that align with flanges on the working surface plate of said Makita tool so that said interface plate can be removably attached to the said working surface plate by standard attachment means such as threaded screws.

3. reciprocating pipe cutter as claimed in claim 1 wherein said said saw wire is approximately fifteen thousandths of an inch in diameter and where said pulleys are approximately one inch in diameter thereby accommodating the minimum bend radius of said saw wire.

4. reciprocating pipe cutter as claimed in claim 1 wherein said first, second and third pulleys include flanges to help retain said saw wire.

5. reciprocating pipe cutter as claimed in claim 1 wherein an alternate embodiment includes an integrated reciprocating tool and pipe cutting assembly rather than a pipe cutting assembly that is added on to an existing reciprocating saw tool.

6. reciprocating pipe cutter as claimed in claim 1 wherein said rotatable pulley arm can swing out to accommodate the cutting of pipes up to two inches in diameter.
